(19) United States
(12) Patent Application Publication
(10) Pub. No.: US 2022/0338462 A1
(43) Pub. Date: Oct. 27, 2022

(54) LUMINESCENT BIRD OF PREY REPLICA

(71) Applicants: Allison M. Kohler, Fort Collins, CO (US); Ray Zifko, Fort Collins, CO (US)

(72) Inventors: Allison M. Kohler, Fort Collins, CO (US); Ray Zifko, Fort Collins, CO (US)

(21) Appl. No.: 17/722,290

(22) Filed: Apr. 15, 2022

Related U.S. Application Data
(60) Provisional application No. 63/178,021, filed on Apr. 22, 2021.

(51) Int. Cl. A01M 29/10; F21K 2/00

(52) U.S. Cl. CPC A01M 29/10; F21K 2/005

(57) ABSTRACT

A luminescent replica comprising a replica of a bird of prey is described. The bird of prey can be an owl, falcon or hawk. The bird of prey can be a great horned owl. The luminescent replica can include a luminescent material on a surface of the replica. The luminescent replica can include a luminescent material on a surface representing a ventral area of the bird of prey. The luminescent material can emit light having a wavelength of from about 600 nm to about 750 nm, and optionally, from about 450 nm to about 500 nm. The luminescent material can absorb ultraviolet radiation having a wavelength of less than about 400 nm. The luminescent material may include a porphyrin or derivative of a porphyrin. A kit and method for making the luminescent replica are also described.

### CROSS REFERENCE TO RELATED APPLICATIONS

This application claims priority to U.S. Provisional Application No. 63/178,021 filed Apr. 22, 2021 to Kohler, entitled “Ultraviolet Fluorescent Decoy,” the contents of which are incorporated by reference in their entirety.

### FIELD OF THE INVENTION

This invention relates generally to a luminescent replica of a bird of prey, and more particularly, to a luminescent replica of an owl, falcon or hawk.

### BACKGROUND OF THE INVENTION

When the behavior biology or location of a species is in direct conflict with people, such as affecting living conditions, spreading disease, harming food supply, the species is considered a pest. Some species of birds and rodents are considered pests because they cause global problems in environments ranging from urban cities to rural farmlands. For example, pests such as pigeons can leave waste in contact with architecture and other infrastructure, resulting in deterioration or disfigurement or enabling the spread of disease. Other examples of pests include European rabbits introduced to Australia over 150 years ago, so that they could be hunted, but have since caused severe damage to Australia's natural environment. Pests such as mice and rats spread disease and can decimate crops. The U.S. alone is estimated to spend billions of dollars each year in dealing with pest impacts, and on a global scale, spending is estimated in the trillions. Though new strategies to combat pests are being explored every day, predator decoys have remained largely unchanged for decades.

### SUMMARY OF THE INVENTION

A luminescent replica described herein comprises a replica of a bird of prey, and a luminescent material on a surface of the replica. The bird of prey can comprise an owl, falcon or hawk. In some embodiments, the bird of prey comprises a great horned owl. The luminescent replica can include a surface area representing a ventral surface of the bird of prey, and the luminescent material is on the surface area representing the ventral surface. In some embodiments, the luminescent material emits light having a wavelength of from about 600 nm to about 750 nm. In some embodiments, the luminescent material emits light having a wavelength of from about 600 nm to about 750 and a wavelength of from about 450 nm to about 500 nm. The luminescent material can absorb ultraviolet (UV) radiation having a wavelength of less than about 400 nm. In some embodiments the luminescent material comprises a porphyrin, an isomer of a porphyrin, or a combination thereof. The luminescent material can comprise a naturally occurring or a non-naturally occurring material that emits light. The luminescent replica comprises a replica of a bird of prey that may be in the form of molded plastic, fabric, wood or a combination thereof.

The luminescent replica of a bird of prey can be used as a decoy that can act as a signaler of a visual cue, intended to either repel or attract the receiver.

A kit for making the luminescent replica of a bird of prey is also described herein. The kit can comprise a replica of the bird of prey, and a supply of the luminescent material.

A method for making the luminescent replica of a bird of prey is also described herein. The method can comprise applying a luminescent material to a surface of the replica.

### BRIEF DESCRIPTION OF THE DRAWINGS

FIGS. 1a-c are perspective views of an exemplary luminescent replica of a bird of prey, with luminescent material disposed on a surface of the replica, in accordance with the invention described herein.

FIGS. 2a-2c are perspective views of an exemplary luminescent replica of a bird of prey, with luminescent material disposed on a surface of the replica, and light emitted by the luminescent material is of more than one intensity, in accordance with the invention described herein.

### DETAILED DESCRIPTION OF THE INVENTION

There are many techniques that can be used to prevent, combat, and mange pests, ranging from prevention to intervention. More recently, integrated pest management has been used where combinations of cultural, physical/mechanical, biological and chemical strategies are implemented to achieve long-lasting solutions. Under this framework, strategies that encourage prevention are generally considered favorable over those used for intervention because biological or chemical intervention involves the use of pesticides which can have negative human health and ecological implications.

A decoy comprises a replica or an imitation of a living species such as a mammal or bird. A decoy can be used to attract or deter one or more livings. For example, decoys are often used by hunters to attract or lure one or more desirable species by trapping or some other means of capture. For another example, decoys can be used to frighten away mammals or birds. It is known that the more realistic the decoy, the more effective it will provide the intended result.

Our understanding of the visual capacities of various species continues to increase. Many species are capable of seeing the world through a different lens from that of human beings. Many species are optically equipped to detect radiation having wavelengths outside of the visible range (generally 400 to 700 nm) of the electromagnetic spectrum. For example, some species can detect UV radiation (generally less than 400 nm) for predator avoidance, foraging or communication.

In general, the luminescent replica described herein comprises a replica of a bird of prey species. In some embodiments, the bird of prey comprises be an owl, falcon or hawk. In some embodiments, the bird of prey comprises the great horned owl (Bubo virginianus). The great horned owl is present year round in the U.S. and is a well-recognized predator. Replicas of the great horned owl are the most commonly used decoys and are available in a range of sizes, shapes, colors and patterning of colors and textures. Replicas of the great horned owl are available from variety of sources including merchants accessible through online resources such as Amazon.com, or traditional in-store merchants such as local hardware stores.

The luminescent replica described herein comprises a luminescent material on a surface of the replica. In general, the luminescent material described herein is luminescent because it emits light having a wavelength in the visible region of the electromagnetic spectrum. Suitable luminescent materials include fluorescent or phosphorescent materials. Fluorescent and phosphorescent materials comprise organic molecules capable of reaching an excited state upon absorption of radiation of a suitable wavelength. Luminescent organic molecules in an excited state return to a ground state, and upon doing so, emit light having a wavelength greater than that of the light absorbed.

Reasons as to why an organic molecule exhibits luminescence, i.e., exhibits fluorescence or phosphorescence, are complex. The difference is often described as being related to the stability of the excited state. Generally, the excited state of a fluorescent material is less stable than that of a phosphorescent material. A fluorescent molecule in an exited state returns to its ground state within nanoseconds. A phosphorescent molecule in an excited state returns to its ground state over a relatively long period of time, for example, over a few seconds to hours long after absorption has occurred and the radiation is no longer available. Phosphorescent materials are sometimes referred to as “glow-in-the-dark” materials.

The luminescent materials useful in the present invention include materials that are UV fluorescent. As used herein, this terminology is used to describe an organic molecule, macromer or polymer that absorbs UV radiation (less than about 400 nm), reaches an excited state, returns to the ground state within nanoseconds, and upon returning to the ground state, emits light having a wavelength in the visible region (from about 400 nm to about 750 nm) of the electromagnetic spectrum. As used herein, UV fluorescent materials include organic molecules, macromers and polymers that absorb UV radiation and subsequently emit light in the visible region. UV fluorescent materials include those that exhibit fluorescence or phosphorescence upon absorption of UV radiation of an appropriate wavelength.

Light incident on the human eye is some combination of red, green and blue light. Light having an emission spectrum corresponding to wavelengths between about 600 to about 750 nm appear red to the human eye, or sometimes appear pink or fuchsia depending on intensity. Light having an emission spectrum corresponding to wavelengths between about 450 to about 500 nm appear blue to the human eye. The combination of red and blue light is often described as magenta light. Light that appears pink or fuchsia to the human eye can be associated with only red light, or some combination of red and blue light.

Any suitable luminescent material may be employed as long as emission occurs in the wavelength region of from about 600 nm to about 750 nm. In some embodiments, the light being emitted has a wavelength of from about 600 nm to about 650 nm. In some embodiments, the luminescent material emits light in more than one region of the visible spectrum. For example, the light being emitted can have a wavelength of from about 600 nm to about 750 and from about 450 nm to about 500 nm.

Bioluminescence is a type of luminescence wherein a living organism is the luminescent material. Bioluminescence has been known to exist in species considered low on the evolutionary scale such as fish, insects and plants. Most known examples of bioluminescence live underwater.

Recent studies have led to the discovery of several bioluminescent vertebrate species that are predominantly land dwellers. The ecological significance of biofluorescence in bird and mammal species remains unclear. Research has shown that some species of birds have tetrachromic color vision, having a fourth cone in their eyes (humans have three cones), such that they can detect UV radiation between about 300-400 nm.

It is possible that the addition of fluorescence to predator decoys, which until now has been overlooked, may be the missing link in making such decoys realistic to a variety of common pests. Herein is described, a luminescent bird of prey replica, which combines the classic pest deterrent method of owl decoys with modern UV technology to reduce pest infestations

For example, predatory owl species have been found to exhibit bioluminescence in the form of UV fluorescence whereby the owls emit a shade of vibrant pink light when exposed to UV radiation having a wavelength below about 400 nm, for example, when exposed to UV radiation from a blacklight emitting at about 395 nm. Biofluorescence found in vertebrate species is described in: Kohler et al., “Ultraviolet fluorescence discovered in New World flying squirrels (Glaucomys)” Journal of Mammology 100(1): 21-30, 2019; Anich et al., “Biofluorescence in the platypus (Ornithorhynchus anatinus)” Mammalia 85(2): 179-181, 2021; and Olson et al., “Vivid biofluorescence discover in the nocturnal Springhare (Pedetidae)” Scientific Reports 11(1): 1-8, 2021. Biofluorescence found in saw-whet owls is described in Weidensaul et al., “The Use of Ultraviolet Light as an Aid in Age Classification of Owls” The Wilson Journal of Ornithology 123(2): 373-377, 2011 and was reported to be porphyrin-mediated and a potential indicator of owl age, however, chemical analysis to confirm the presence of porphyrin was not carried out and relied on previous literature.

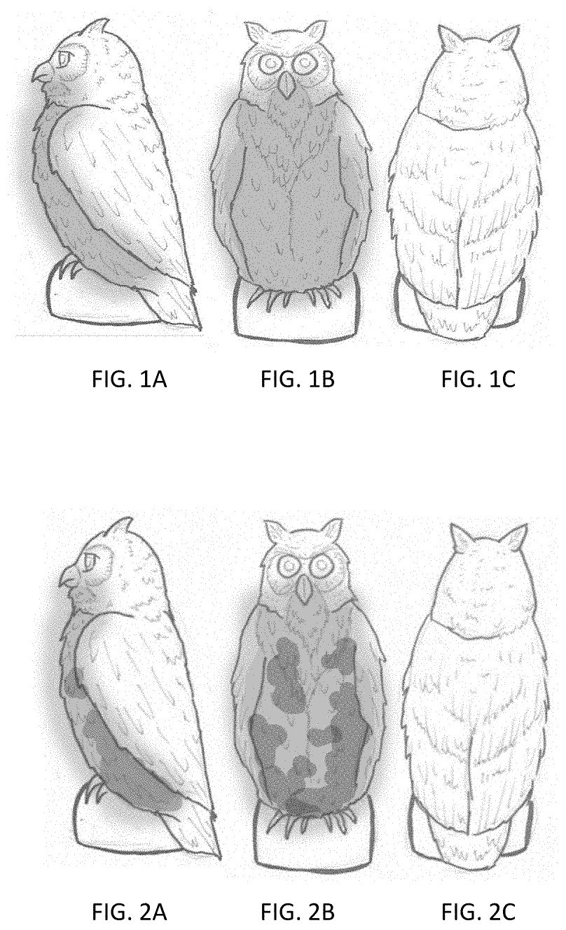

FIGS. 1A-C are perspective views of an exemplary luminescent replica of a bird of prey, with luminescent material disposed on a surface of the replica, in accordance with the invention described herein. FIG. 1A shows a side view of the exemplary luminescent replica, FIG. 1B shows a front or ventral view, and FIG. 1C shows a back or dorsal view. The luminescent replica shown in FIGS. 1A-1C is that of a great horned owl. The shaded area represents surface area of the replica with luminescent material disposed on the surface area, and wherein the luminescent material is emitting light as described herein. Light being emitted by the luminescent replica may be any color as observed by the human eye, for example, the light may appear pink to the human eye. As can be seen from in FIGS. 1A and 1B, the shaded area is limited to covering a ventral area, particularly an abdominal area of the replica. As can be seen in FIG. 1C, there is no shading observable when the luminescent replica is viewed from behind.

FIGS. 2A-C are perspective views of an exemplary luminescent replica of a bird of prey, with luminescent material disposed on a surface of the replica, in accordance with the invention described herein. This embodiment is similar to that shown in FIGS. 1A-1C, except that light is being emitted at more than one intensity. The luminescent material is disposed in a nonrandom manner, with some abdominal areas having more luminescent material than other abdominal areas. Light being emitted by the luminescent replica may be any color as observed by the human eye, for example, the light may appear pink to the human eye. For an example in which light is being emitted at two intensities, the darker shaded areas appear more intense, or saturated, as compared to the lighter shaded areas. FIG. 2A shows a side view of the exemplary luminescent replica, FIG. 2B shows a front or ventral view, and FIG. 2C shows a back or dorsal view. The luminescent replica shown in FIGS. 2A-2C is that of a great horned owl. As can be seen from in FIGS. 2A and 2B, the shaded area is limited to covering a ventral area, particularly an abdominal area of the replica. As can be seen in FIG. 2C, there is no shading observable when the luminescent replica is viewed from behind.

The exemplary luminescent replica shown in FIGS. 2A-2C shows light being emitted at more than one intensity. In general, any number of intensities may be employed, for example, the luminescent material may be disposed on the replica such that the resulting luminescent replica emits light of two or more, three or more, etc. different intensities. As used herein, a difference in intensities can be whatever difference is observable by the human eye.

It is envisioned that UV fluorescence may be used with other decoy species. Precise patterning of the fluorescence and/or fluorescent material to efficiently deter pests may or may not imitate realistic fluorescent patterning. For example, anecdotal evidence indicates that owls generally fluoresce more on their ventral surfaces and under their wings; thus, fluorescence and/or fluorescent material may be applied or radiate more substantially on the undersides of the owl decoys to reflect lifelike patterning. Although fluorescence in great horned owls is likely due to porphyrin compounds, other such materials are envisioned here to produce fluorescence. Such materials include, but are not limited to porphyrin-based compounds, fluorescent paints and dyes, biomedical-grade fluorescent compounds, etc.

The luminescent bird of prey replica can include any luminescent material as long as it can function as desired. In some embodiments, for applications in which a pink color is desired, the luminescent material can comprise a porphyrin, an isomer of a porphyrin, or a combination thereof Exemplary porphyrins include protoporphyrins, uroporphyrins, coproporphyrins, or combinations thereof. Exemplary porphyrins also include metalloporphyrins, for example, porphyrin complexed to iron or an iron cation referred to as heme porphyrins. The porphyrin can comprise any suitable naturally occurring porphyrin such as any of those described above. The porphyrin can comprise a non-naturally occurring porphyrin sometimes referred to as a synthetic porphyrin such as octaethylporphyrin and the like.

The luminescent material can include additional components that are, or that form, a polymeric binder or vehicle for the luminescent component. For example, the polymeric component can be combined with the luminescent component and upon drying, forms a weather resistant film on the replica. Crosslinking technology may be employed; polymeric components may be crosslinked as films are formed, or macromers that crosslink may be used.

The luminescent material can include additional components to aid dispersion, uniformity, stability, etc. of the luminescent material. For example, small molecule organic components such as surfactants may be present in the luminescent material.

The replica used to form the luminescent bird of prey replica can be made from any suitable material such as a polymeric material or plastic, fabric such as canvas, or wood. The replica can be formed from a polymeric material such that seams may or may not be present, depending on how the replica is molded. In general, the replica can be a single part. The replica can comprise two parts, for example, head and body parts, which may or may not be intended to be detached by a user.

In some embodiments, the replica used to form the luminescent replica may comprise two different materials. For example, the replica may comprise a single molded polymeric part configured to be attachable to some type of woven or non-woven fabric material. The luminescent material may be disposed on the fabric material, or impregnated into the fabric material. In this way, additional luminescent material can be applied to the fabric, if the luminescent bird of prey replica weathers and loses luminescent capacity. The fabric material may be removably attached to replica. For example, a fabric material having luminescent material thereon can be a replacement if the luminescent replica weathers and loses luminescence capacity. Attaching the fabric material comprises attaching with adhesive or mechanical means such as hook and loop fasteners such as Velcro®.

The luminescent bird of prey replica may comprise means for attaching to another object such as a tree trunk, tree branches, a nesting box, a rooftop or railing such as an outdoor metal or wooden fence or railing. Suitable means for attaching include a support or base, clips, loops or hooks or external tags for nailing the luminescent bird of prey replica to another object.

Also disclosed herein is a kit for making the luminescent bird of prey replica. The kit can include a bird of prey replica as described above and a supply of one or more luminescent materials. The kit may include one or more applicators such as brushes, sponges or the like, for applying the luminescent material to the replica.

Various modifications and additions can be made to the exemplary embodiments discussed herein without departing from the scope of the disclosed subject matter. For example, while the embodiments described refer to particular features, the scope of this disclosure includes embodiments having different combinations of the features and embodiments that do not include all of the described features. Accordingly, the scope of the disclosed subject matter is intended to embrace all such alternatives, modifications, and variations, together with all equivalents thereof. This application claims the invention described herein to the broadest extent possible as substantially disclosed herein.

What is claimed is:

1. A luminescent replica comprising
a replica of a bird of prey, and
a luminescent material on a surface of the replica.

2. The luminescent replica of claim 1 wherein the bird of prey comprises an owl, falcon or hawk.

3. The luminescent replica of claim 1 wherein the bird of prey comprises a great horned owl.

4. The luminescent replica of claim 1 wherein the replica includes surface area representing a ventral surface of the bird of prey, and the luminescent material is on the surface area representing the ventral surface.

5. The luminescent replica of claim 3 wherein the replica includes surface area representing a dorsal surface of the bird of prey, and the luminescent material is not on the surface area representing the dorsal surface.

6. The luminescent replica of claim 1 wherein the luminescent material emits light having at least two intensities.

7. The luminescent replica of claim 1 wherein the luminescent material emits light having a wavelength of from about 600 nm to about 750 nm.

8. The luminescent replica of claim 7 wherein the luminescent material emits light having a wavelength of from about 450 nm to about 500 nm.

9. The luminescent replica of claim 1 wherein the luminescent material absorbs ultraviolet radiation having a wavelength of less than about 400 nm.

10. The luminescent replica of claim 1 wherein the luminescent material comprises a porphyrin, an isomer of a porphyrin, or a combination thereof.

11. The luminescent replica of claim 1 wherein the luminescent material comprises a protoporphyrin, a uroporphyrin, a coproporphyrin, a metalloporphyrin or a combination thereof.

12. The luminescent replica of claim 1 wherein the luminescent material comprises a non-naturally occurring porphyrin.

13. The luminescent replica of claim 1 wherein the luminescent material comprises a crosslinked polymeric binder.

14. The luminescent replica of claim 1 wherein the replica comprises molded plastic.

15. The luminescent replica of claim 1 wherein the replica comprises fabric and the luminescent material is disposed on the fabric.

16. The luminescent replica of claim 14 wherein the fabric is removably attached to the replica.

17. The luminescent replica of claim 1 further comprising means for affixing the luminescent replica to a tree, nesting box, rooftop or railing.

18. A kit for making a luminescent replica of a bird of prey, comprising:
a replica of a bird of prey, and
a supply of luminescent material.

19. The kit of claim 18 wherein the bird of prey comprises an owl, falcon or hawk.

20. A method of making a luminescent replica of a bird of prey, comprising:
applying a luminescent material to a surface of the replica.
